(19) United States
(12) Patent Application Publication
(10) Pub. No.: US 2019/0351773 A1
(43) Pub. Date: Nov. 21, 2019

(54) Mobile electric vehicle charging station employing multiple power sources

(71) Applicant: Thomas Duran Merritt, Hollywood, FL (US)

(72) Inventor: Thomas Duran Merritt, Hollywood, FL (US)

(21) Appl. No.: 15/932,885

(22) Filed: May 15, 2018

(51) Int. Cl. B60L 11/18; H02J 7/00; H02J 3/38

(52) U.S. Cl. CPC B60L 11/1824; H02J 7/0027; B60F 3/003; H02J 3/386; H02J 3/383

(57) ABSTRACT

A mobile power station for the purpose of recharging electric vehicles is provided. The charging station includes separate, but different, types of electrical generation capabilities. For example, the charging station may include two or more of: wind power, solar power and power generated from oscillators, which charge its battery pack over land. If desired, the mobile power station can be amphibious, as well, and can navigate large bodies of water.

### CROSS-REFERENCE TO RELATED APPLICATIONS

The present application claims benefit of co-pending Provisional Patent Application No. 62/507,440, filed on May 17, 2017, entitled Mobile Electric Vehicle Charging Station Employing Multiple Power Sources, that application being incorporated herein, by reference, in its entirety.

### BACKGROUND OF THE INVENTION

### Field of the Invention

The invention relates to a mobile electric vehicle charging station employing multiple power sources. In one particular embodiment, the charging station additionally has amphibious capabilities.

### Description of the Related Art

In contemporary times, hybrid electric vehicles have become profuse around the world. These fuel saving designs have become popular because of their high mileage characteristics. However, certain vehicle manufacturers have moved to design and implement pure electric powered vehicles. These vehicles have eliminated the necessity for gasoline or diesel engines as part of the design. A drawback to this apparent progress, however, is the necessity of recharging these vehicles from time to time, thereby limiting the distance they are able to travel. To alleviate this situation, electric vehicle charging stations are being constructed along many routes of our highway system.

When not traveling great distances, the users of electric vehicles can recharge them at their residences, using high cost electricity, which can equal or surpass the cost of the previously used fuels, such as gas, diesel, or natural gas. This fact can weigh on the decision of the consumer whether or not to purchase an all electric vehicle, to begin with.

What is needed is a mobile, electric vehicle power charging device that has the ability to recharge itself during operation.

### BRIEF SUMMARY OF THE INVENTION

It is accordingly an object of the invention to provide a mobile, electric vehicle power charging station that solves the disadvantages of the prior art. More particularly, a mobile, electric vehicle power charging device is provided that includes inexpensive solar and wind power to achieve recharging, thus recharging itself during operation. In one particular embodiment, the power charging station also utilizes gravity, through the user of linear generators embedded within suspension components of the mobile device, to generate power while moving along the surface of the earth.

Although the invention is illustrated and described herein as embodied in a mobile electric vehicle charging station employing multiple power sources, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a top plan view of a mobile, electric vehicle charging station employing multiple power sources in accordance with one particular embodiment of the invention;

FIG. 2 is a side plan view of a mobile, electric vehicle charging station employing multiple power sources in accordance with one particular embodiment of the invention;

FIG. 3 is a perspective view of one particular embodiment of a mobile, electric vehicle charging station according to the invention;

FIG. 4 is a generalized circuit diagram for a mobile, electric vehicle charging station in accordance with one particular embodiment of the invention;

FIG. 5 is a perspective view of a mobile charging station in accordance with another embodiment of the invention.

### DETAILED DESCRIPTION OF THE INVENTION

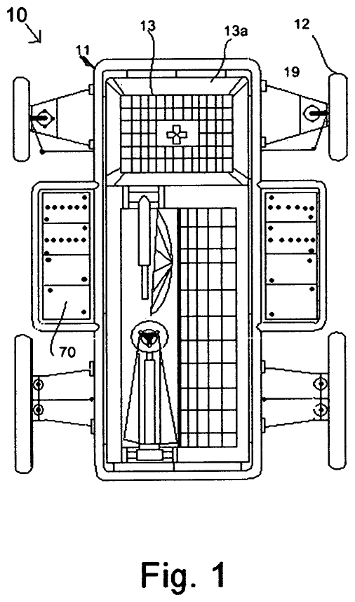

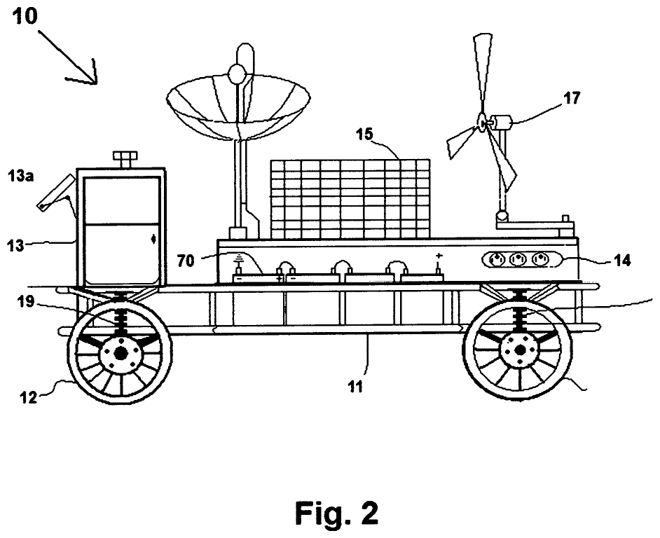

Referring now to FIGS. 1-3, there is illustrated one particular embodiment of a mobile, electric vehicle charging station 10 employing multiple power sources for its own recharging, during operation. More particularly, the charging station 10 includes a plurality of different, power sources. In one embodiment, the charging station 10 includes both inexpensive solar panels 110 and a wind turbine 120 for generating power from the wind. In another embodiment, the charging station 10 additionally includes linear generators embedded within suspension components of the charging station 10 to generate power while moving along the surface of the earth. Such linear generators can be, for example, the linear generators described in U.S. Pat. No. 4,500,827, issued on Feb. 19, 1985 to Thomas Merritt, et al. The power generated is stored in a battery pack or packs in combination with supercapacitors onboard the charging station 10. The charging station, being electrically powered, therefore, can travel immense distances without the necessity of having to be recharged from an external source.

The mobile electric charging station 10 can also, optionally, have amphibious capabilities, thereby, giving it the capability to navigate lakes to reach electric boats that need recharging. Specifically, the mobile charging station described herein, by way of its multiple charging mechanisms, has the ability to operate continuously with no external recharging connection, as well as having the ability to recharge other separate electrical apparatuses requiring a charge, in any remote or urban location, thus fulfilling an emerging need.

Referring now to FIG. 1, the mobile, electric vehicle, charging station 10 includes a chassis 11, which is substantially supported by the wheels 12, of which there are four, in the present preferred embodiment. Wheels 12 can be selected to permit the mobile charging station to travel on road and/or off road, as desired. Additionally, the wheels 12 can be omitted, moved or removed for amphibious use of the charging station 10, i.e., to charge electric boats. The charging station 10 can additionally include an operator's compartment 13, from which the charging station 10 can be operated. Operator's compartment 13 can include windows or viewing ports 13a to permit the operator to see outside the compartment 13. In one particular embodiment of the invention, the operator's compartment 13 is mounted to the front portion of the charging station 10. Additionally, although not illustrated, a steering mechanism is provided to enable an operator to steer the wheels 12 and to proceed in the forward and reverse directions.

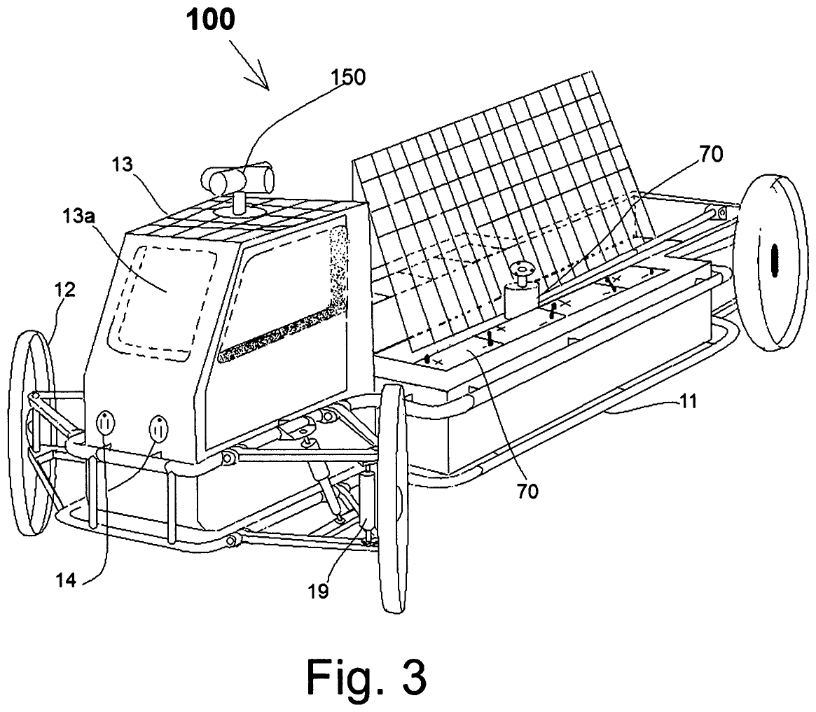

In accordance with the present invention, two or more power sources are provided for charging the battery pack of the mobile charging station 10. In the embodiment illustrated in FIG. 3, three power sources are used. For example, the charging station 10 includes: 1) fold-out solar panel wings or sails 15, for solar charging; 2) a fold-down wind turbine 17, for wind power charging; and 3) linear generators 19 for using gravity for charging. Note that this is not meant to be limiting, as other charging methods can be selected, so long as two or more charging methods are used.

Additionally, the charging station is provided with one or more electrical sockets 14 for connection to a vehicle to be charged or to an external charging source. For example, the sockets 14 permit the charging station 10 to be attached to another vehicle (not shown), via an electrical cable or conductor, to charge the other vehicle, or can be used to attach the charging station 10 to a power source, such as an off-grid or on-grid power supply at a user's dwelling.

In one particular embodiment of the invention, the mobile charging station 10 is a motorized vehicle, not a device that is passively carried or pulled.

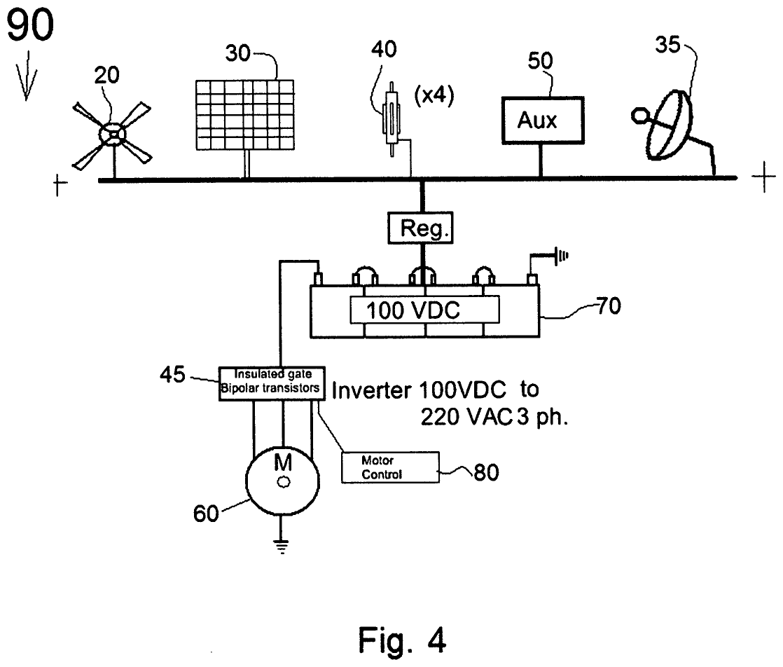

Referring now to FIG. 4, a generalized circuit diagram 90 for a mobile, electric vehicle charging station including multiple, different power sources, such as 10 of FIGS. 1-3, will now be described. In the preferred embodiment illustrated, five different power sources are provided for recharging the charging station. A wind turbine 20 is provided that, when the rotor blades are turned by the wind, can generate electricity that is stored in the station 10. It is not uncommon for a wind turbine having as small a diameter as 4 feet to produce significant amounts of power with merely a 3 mph wind. If desired, more than one wind turbine 20 may be provided. Similarly, one or more solar panels 30 are provided that additionally generate electricity that can be stored in the station 10. One or more linear generators 40, as discussed above, are positioned on the struts of the vehicle and use gravity to generate electricity that gets stored in the station 10. In one particular embodiment, four linear generators 40 are provided—one associated with each wheel 12 of the charging station 10. Additionally, if desired, an auxiliary input/output 80 is provided that can be used as an input to charge the station 10 from an external power supply or as an output, for connection to a vehicle to be charged. A control, 80 such as a processor or computing element, is additionally provided to control the elements of station 10.

Each of the power sources 20, 30, 35, 40, 50 preferably provides more than 24 volts to the station 10. Electricity produced from the power sources 20, 30, 35, 40, 50 is regulated by a regulator and stored in the bank of batteries or battery pack 70. In one particular embodiment, the battery pack includes four batteries, storing a maximum of 100 DC volts which can be drawn upon for recharging another vehicle or for powering an electric drive motor 60 of the mobile, electric vehicle charging station 10, via an inverter 45. The drive motor 60 is used to move the charging station 10 to where it is needed.

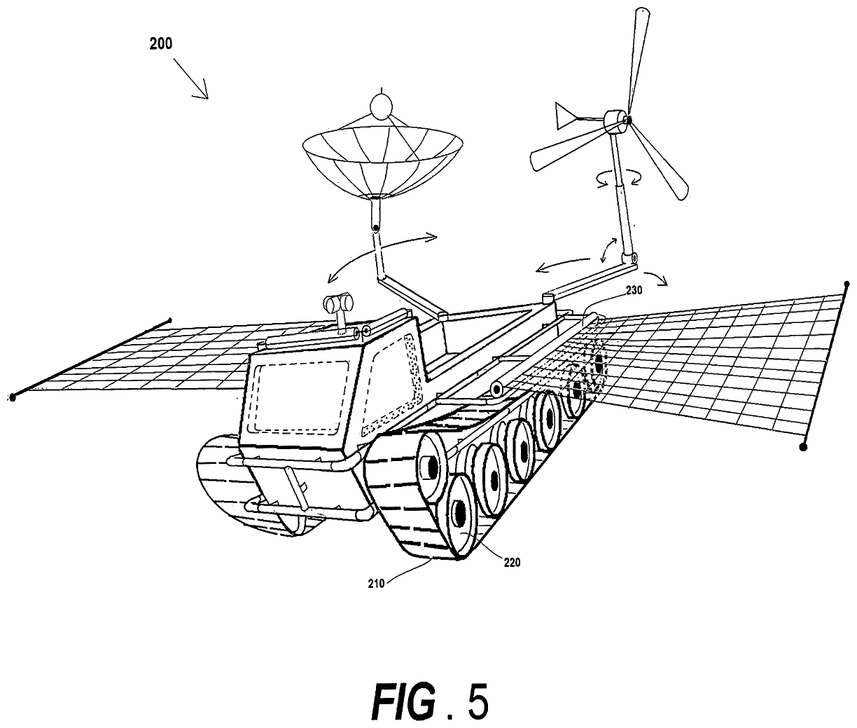

Referring now to FIG. 5, another embodiment of a mobile, electric vehicle charging station 100, in accordance with the present invention. Charging station 100 has the ability to deploy a very large array of solar panels 110, by folding them compactly for storage, and unfolding them for deployment, as illustrated. Note that, even when folded for storage, a portion of the solar cells of the solar array are exposed to sunlight, thereby providing power during all sunlight hours, even when not in use. Additionally, the wind turbine assembly 120 can be folded and lowered into a storage compartment 130. In one particular embodiment, the wind turbine assembly 120 is located atop a telescoping shaft 125, and is rotatable 360° about the telescoping shaft 125.

The charging station 100 additionally includes an operator's compartment 140 in which an operator can sit while moving the charging station 100 to a desired location. In one particular embodiment of the invention, the enclosure forming the operator's compartment is made using a high “R” value insulation, which is then covered by a hardened fabric, such as carbon fiber or Kevlar®. The insulation used for the enclosure of the operator's compartment is, in one particular embodiment, composed of closed cell urethane, or another, similar material (i.e., EPP foam, EPS foam, etc.). This provides protection to the operator in hazardous areas of operation.

As, in the present embodiment, the viewing ports are completely obscured by the hardened fabric covering, 360° vision is provided through the use of closed-circuit TV (CCTV) cameras 150 mounted on the exterior of the operator's compartment 140. The CCTV cameras 150 are connected to monitors 160 on the interior of the operator's compartment 140. In one embodiment, four (front-facing, rear-facing, left-side and right-side facing) CCTV cameras 150 are provided, with four corresponding monitors 160 being provided inside the operator's compartment 140.

As a result of the high R value of the insulation, the operator's compartment 140 may be heated or cooled using a miniscule or negligible amount of energy, for the operator's comfort. The particularly described closed-cell foam composition of the operator's compartment will provide additional buoyancy for amphibious operation, as well.

If desired, the entire body of the charging station 100 can be constructed using structural foam covered with a hardened fabric, such as carbon fiber, and surrounded by a tubular frame 180, to which the wheeled support units are attached. Although not illustrated in FIG. 5, linear generators, as described above in connection with FIGS. 1-4, can be provided. Similarly, a steering mechanism would be included for use by an operator.

Additionally, since power can be received from, and provided to, the charging station 100, electrical connections, sockets or outlets 170 are placed at various location on the charging station 100. Electrical connections 170 permit the charging station to be recharged from an external source, as well as providing power to other electric vehicles that need to be charged.

Referring again to FIG. 5, there is illustrated further embodiment of a mobile charging station 200 in accordance with the present invention. The mobile charging station 200 is provided with tracks or treads 210 driven by two or more wheels 220, instead of only the wheels (12 of FIG. 1) illustrated in the previous embodiments. This gives the station 200 the ability to traverse extremely rugged terrain, granting the mobile charging station 200 access to the most remote regions. A mobile charging station 200, which is, of course, electrically powered, would be useful for silently powering military command posts or for disaster relief, rescue operations, and/or providing access to snowbound areas, among other operations. All other elements of the station 200 can be as disclosed in connection with the station 100 of FIG. 3.

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

1. A mobile charging station, comprising:
two or more power sources chosen from the group including: solar, wind, gravity;
at least one electrical connection for charging an electric vehicle; and
a drive mechanism for moving the charging station.

2. The mobile charging station of claim 1, further comprising a closed foam material body covered, at least in part with a hardened fabric material.

3. The mobile charging station of claim 2, wherein the hardened fabric material is a carbon fiber material.

4. The mobile charging station of claim 1, wherein the charging station can travel on road or off road.

5. The mobile charging station of claim 1, wherein the charging station is buoyant and can travel in water.
